(19) United States
(12) Patent Application Publication
(10) Pub. No.: US 2005/0198658 A1
(43) Pub. Date: Sep. 8, 2005

(54) Optical Storage medium with an anti-bumping system

(76) Inventor: Chang Lung Yu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/838,263

(22) Filed: May 5, 2004

(30) Foreign Application Priority Data
Mar. 5, 2004 (TW) 093203338

(51) Int. Cl. G11B 33/14

(52) U.S. Cl. 720/648

(57) ABSTRACT

An optical storage medium with an anti-bumping system comprises a body device; a module device embodied in the body device including a readable or a recording module mounted with a frame, the readable or recording module at least including a readable or a recording mechanism and related electrical components; a transmission device including a motor and a rotor, the motor mounting to the module device and connecting with the power, the rotor connecting with the motor for transmission; an anti-bumping system including an anti-bumping board, the anti-bumping board mounting to the module device. It can balance the up-down airflow pressure under the high-speed operation for ensuring the readable and recording quality of an optical storage disk.

### BACKGROUND OF THE INVENTION

1. Field of the Invention

The present invention relates to an optical storage medium. More particularly, it is with an anti-bumping system thereto balances the up-down airflow pressure under the high-speed operation for enhancing the readable and recording quality in an optical storage disk in the optical storage medium with an anti-bumping system.

2. Description of the Related Art

Conventionally, an optical storage medium (such as CD/R and CD/RM; DVD−/+R and DVD−/+RW; DVD/CD, and etc.) reads and writes data in an optical storage device for implementing the data storage. As shown in FIG. 1, after the optical storage disk 91 is processing burning operation and is positioned on the tray 92 of the optical storage medium, it is supported by the disk rotor 94 which is connected upon the motor 93. Then, it is mounted to the pick-up apparatus 96 of the cover 95 in the optical storage disk and positioned for the optical storage disk 91. While optical storage disk is rotated and processing the burning operation, the airflow field phenomenon is occurred by airflow filed between the optical storage disk 91 and the bottom of the tray 92, and between the optical storage disk 91 and top of the cover 95. The airflow field phenomenon causes the stability for the optical storage disk 91 operation. The trend of the optical storage disk development tends to have high capacity. By increasing capacity, the data density per unit is also increased. More, following the high-speed operation, a light air flow field (AFF) change is reflected to the recording quality real-time.

In order to solve the disturbance problem caused by internal air-flow field phenomenon in the optical storage medium, the present solution mainly uses noise absorption pad adhered to the inner of the optical storage medium. The present common usage utilizes the fluffy noise-absorption pad to adhere to the inner of the optical storage medium. By using the pad affects airflow guide-in reaction as well as to absorb airflow to produce wind shear noise.

However, the present medium with the foam by guide-in airflow technique presents different storage quality by different foam materials and different adhesion positions. Therefore, looking at the trend in high speed and large transmission capacity of the optical storage medium, choices of foam material and adhesion position become important factors. However, they become instable factor for mass production. Then, the best solution is to use guide-in airflow technique by adhering foam, which is still waiting for industrial people to develop and research on this field.

According to the above mentioned shortages of guide-in airflow field by using foam in the optical storage medium, such as bumping and structural defects in the instable readable and recording quality. The present invention is to provide an optical storage medium with a stably readable and recording quality of an anti-bumping system for the industry.

### SUMMARY OF THE INVENTION

The present invention is to provide an optical storage medium with an anti-bumping system, which can balance the up-down airflow pressure under the high-speed operation for avoiding non-uniform airflow pressure to reform a local pressure in the optical storage disk thereto ensuring the readable and recording quality in the optical storage disk.

One of the objects in the present invention is to provide an optical storage medium with an anti-bumping system, which can easily assembly and position for the optical storage medium in mass productions. More, it can enhance the efficiency in the manufacturing assembly.

In order to achieve the mentioned functions and purposes, the present invention includes: a body device; a module device embodied to the body device including a readable or recording module mounted with a frame; the readable or recording module at least including a readable or recording mechanism and related electrical components; a transmission device including a motor and a rotor, the motor mounting to the module device and connecting with the power, the rotor connecting with the motor for transmission; an anti-bumping system including an anti-bumping board, the anti-bumping board mounting to the module device. The present invention, therefore, can balance the up-down airflow pressure under the high-speed operation for ensuring the readable and recording quality of an optical storage disk. The present invention can change the inner of the airflow field structure in the optical storage medium. More, it can guide in the airflow to the inner of the optical storage medium for not forming deformation in the optical storage disk by the locally airflow pressure of the inner of the airflow field while under the high-speed operation. Further, it can enhance the ability of the optical storage medium thereto ensure the reading and recording quality.

### BRIEF DESCRIPTION OF THE DRAWINGS

The features and advantages of the present invention will become apparent from the following detailed description in combination with the figures listed below.

FIG. 1 illustrates one 3-D embodiment of the optical storage medium which implements the teachings of the present invention.

FIG. 1A is one partially enlarged embodiment of the present invention.

FIG. 2 illustrates one partially 3-D assembling embodiment of the present invention.

FIG. 3 illustrates one partially assembling top view of the present invention.

FIG. 4 illustrates the airflow field of the readable and burning operations in the present invention.

FIG. 5 illustrates the airflow field of the conventional optical storage medium.

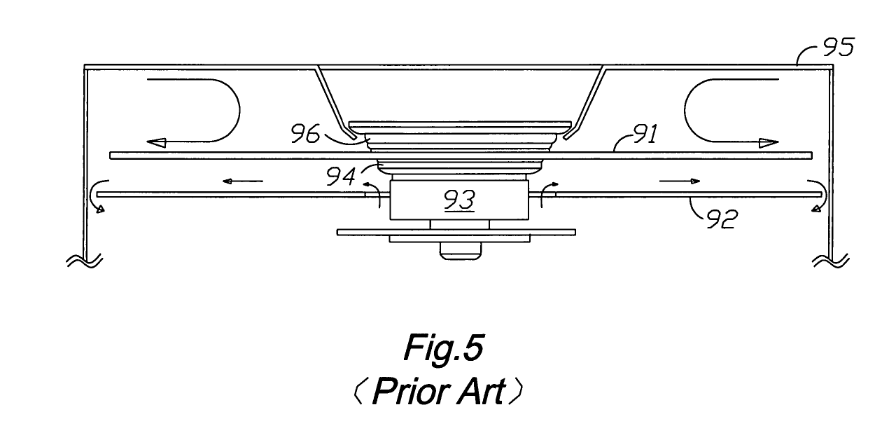

### DETAILED DESCRIPTION OF THE PREFERRED EMBODIMENT

The features and advantages of the present invention will become apparent from the following detailed description in combination with the figures listed below.

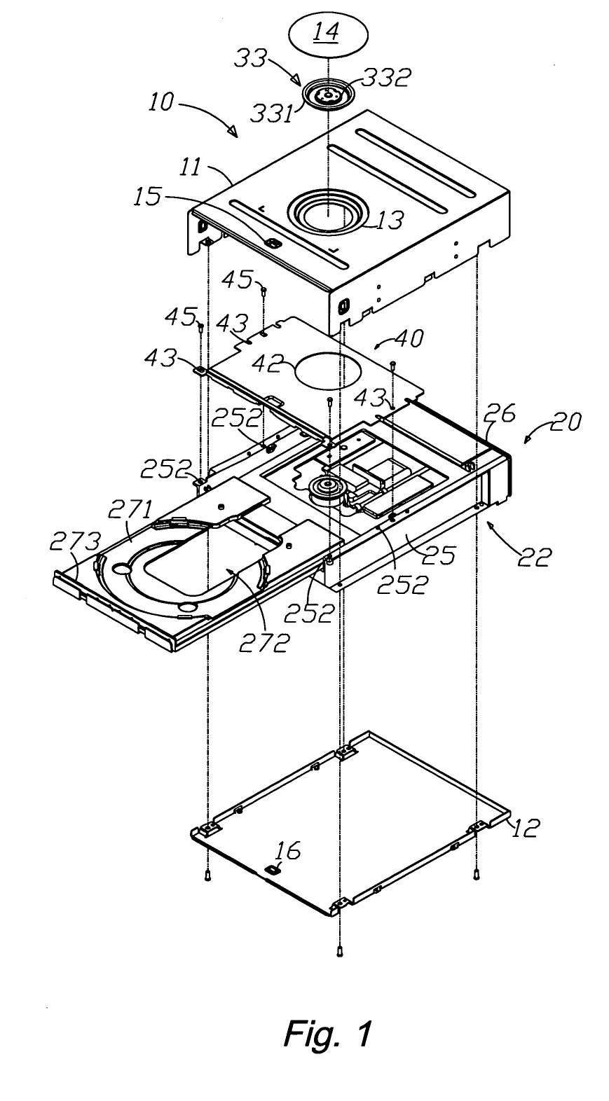

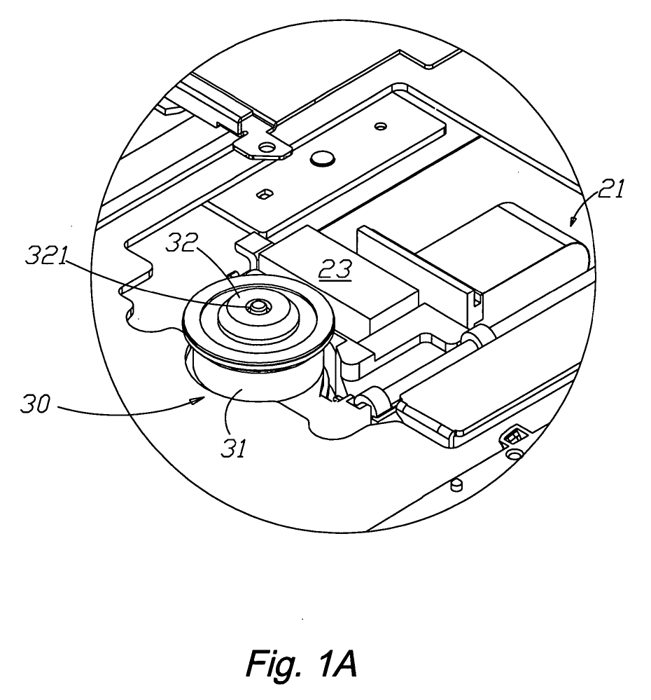

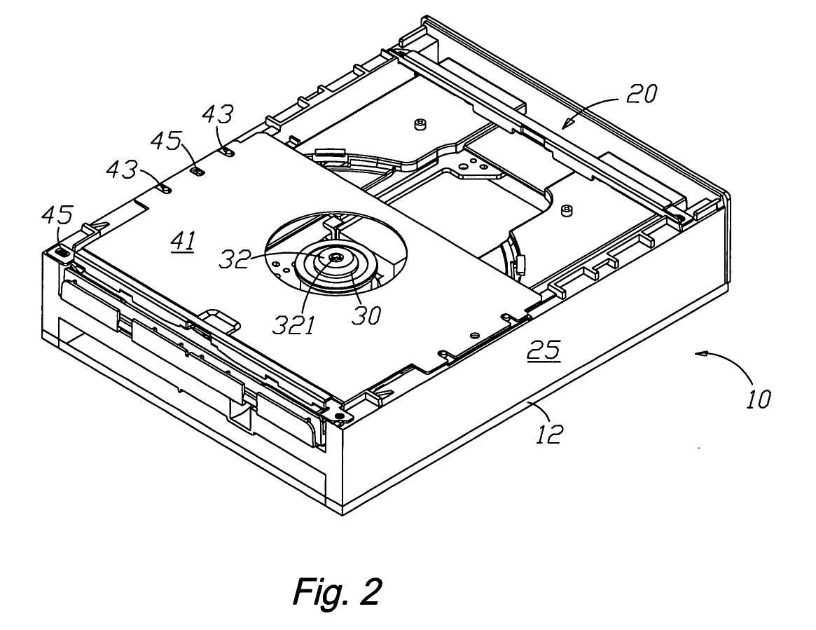

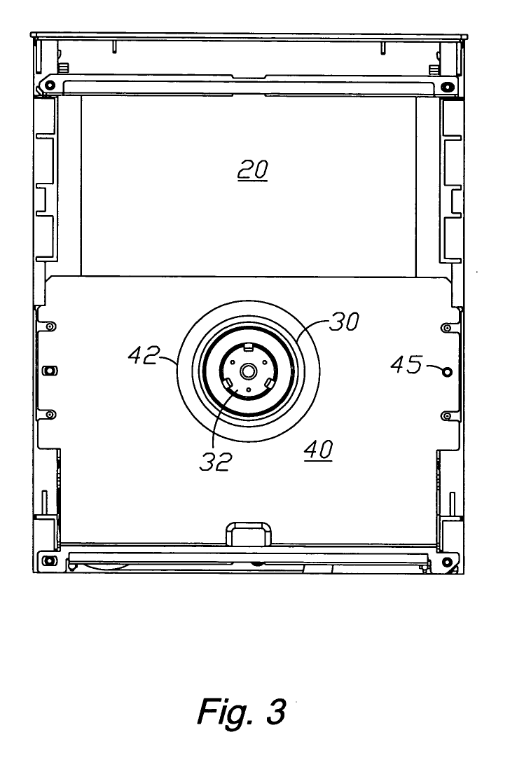

Please referring to FIG. 1 to FIG. 3, the present invention with an anti-bumping system of an optical storage medium comprises a body device 10, a module device 20, a transmission device 30 and an anti-bumping system 40. The body device 10 includes an up body 11 and a down body 12 which are screwed to wedge together. The up body 11 has a concave through hole 13. The concave through hole 13 is with a cover 14. The front side of the down body 12 has two wedged holes 15 and 16 separately. The module device 20 includes a readable or recording module 21, and a frame 22. The readable or recording module 21 is mounted on the frame 22, which includes a readable or a recording mechanism 23, and related electrical components for implementing the readable or recording function. In addition, the readable or recording module 21 can be with both readable and recording functions of the module. In another words, it means that the module can individually includes either a readable function or a recording function, or both readable and recording functions. The frame 22 can be wedged on the down body 12, which includes the both side frames 25 and a back frame with a wedged combination. The top fringe of the side frame 25 has a frame side 251. There are multiple screw holes 252 on the frame side 251. In the middle part of the frames 25 has a tray 27. The tray 27 can be activated to process the slidingly extending and the draw back operations. The tray 27 has a concave 271 and a readable and recording through hole 272. The concave 271 is for placing the tray, and the readable and recording through hole 272 is the through hole for reading and writing operations. More, the front side of the tray 27 has a wedged board 273.

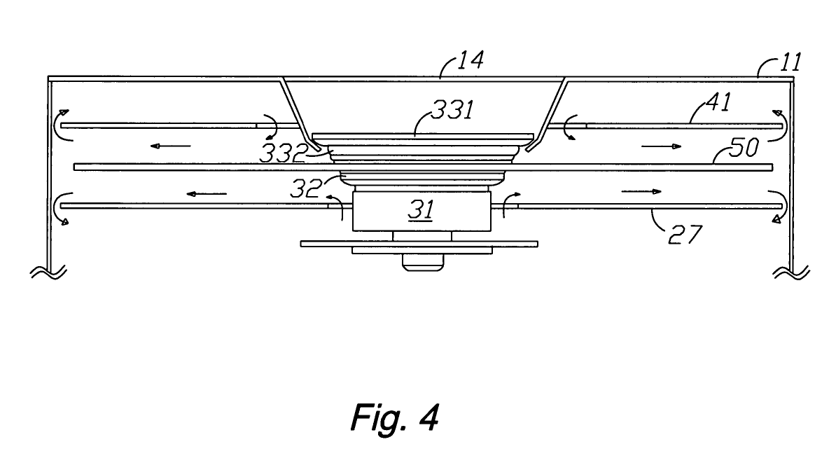

The transmission apparatus 30 comprises a motor 31, a rotor 32 and a pick-up apparatus 33. The motor 31 is mounted on the module device 20 and connects with the power. The rotor 32 is mounted on the top side of the motor 31 and is activated by the motor 31. The middle part of the rotor 32 has a rotor axis 32). The pick-up apparatus 33 comprises a pick-up tray 331 and a pick-up head 332 with the connection (please also referring to FIG. 4). The pick-up tray 331 is positioned on the concave through hole 13 of the up body 11. The pick-up head 332 down extends to the body device 10 for mounting to the optical storage disk 50 as the position.

The anti-bumping system 40 embodied to the module device 20 includes an anti-bumping board 41. The anti-bumping board should be a rigid structure as the best embodiment, which has a through hole 42, multiple screw holes 43 on the both sides, and a back board 44 faced to the down side of the front part. The assembly is to use screw 45 to fix the screw hole 43 of the both sides in the anti-bumping board 41 with the screw hole 252 of the side frame 25 for implementing the assembly of the anti-bumping board 41. The anti-bumping board 41 is covered on the front part of the module device 20.

Please also referring to FIG. 4, while processing the reading and burning operations, the optical storage disk 50 on the try 20 is supported by the rotor 32. Also, it is positioned by the pick-up head 332 and the rotor 32, sequently makes the motor 31 actuate the optical storage disk 50 rotated. Since the anti-bumping board 41 is positioned between the optical storage disk 50 and the up body 11, the optical storage disk can balance the up-down airflow field by the anti-stable board 41 and the tray 27 while rotation. Therefore, it can stably implement the reading and burning operations for the optical storage disk 50.

The present invention is an improved optical storage medium with an anti-bumping structure by the above mentioned design. It can change the inner of the airflow field structure in the optical storage medium. More, it can guide in the airflow to the inner of the optical storage medium for not forming deformation in the optical storage disk by the local airflow pressure of the inner of the airflow field while under the high-speed operation. Further, it can enhance the ability of the optical storage medium thereto ensure the reading and recording quality.

The present invention described herein may be designed in many different embodiments and using many different configurations. While the present invention has been described in terms of various embodiments, other embodiments may come to mind to those skilled in the art without departing from the spirit and scope of the present invention. The invention should, therefore, be measured in terms of the claims which follow.

1. An optical storage medium with an anti-bumping system comprising;
a body device;
a module device mounted in said body device including a frame and some related electrical components with connection;
a transmission device including a motor and a rotor, wherein said motor is mounted to said module device and connects with the power, said rotor connects with said motor for transmission; and
an ant-bumping system including an ant-bumping board, wherein said anti-bumping board is mounted to said module device.

2. The apparatus of claim 1, wherein said frame of the optical storage medium with anti-bumping system is mounted to said body device.

3. The apparatus of claim 1, wherein said module device of the optical storage medium with an anti-bumping system includes a readable module which at least has one readable mechanism.

4. The apparatus of claim 1, wherein said module device of the optical storage medium with anti-bumping system includes a recording module which at least has one recording mechanism.

5. The apparatus of claim 1, wherein said anti-bumping board of the optical storage medium with anti-bumping system is mounted to the frame of said module device as the preferred embodiment.

6. The apparatus of claim 1, wherein said anti-bumping board of the optical storage medium with anti-bumping system is screwed with the frame of said module device.

7. The apparatus of claim 1, wherein said transmission device of the optical storage medium with anti-bumping system includes a pick-up apparatus of said body device which is wedged with said rotor.

8. The apparatus of claim 1, wherein said anti-bumping board of the optical storage medium with anti-bumping system can be a rigid structure as the preferred embodiment.

9. The apparatus of claim 1, wherein said anti-bumping board of the optical storage medium with anti-bumping system should have a through hole.

10. An optical storage medium with an anti-bumping system comprising;
a module device;
a transmission device including a motor and a rotor, wherein said motor is mounted on said module device and connects with the power, and said rotor connects with said motor for transmission; and
an anti-bumping system including an anti-bumping board, wherein said anti-bumping board is mounted on said module device.

11. The apparatus of claim 10, wherein said module device of the optical storage medium with anti-bumping system includes a readable module.

12. The apparatus of claim 10, wherein said module device of the optical storage medium with anti-bumping system includes a recording module.

13. The apparatus of claim 10, wherein said module device of the optical storage medium with anti-bumping system includes a frame, and said anti-bumping board is positioned on said frame of said module device as the preferred embodiment.

14. The apparatus of claim 10, wherein said anti-bumping board of the optical storage medium with anti-bumping system should be screwed with the frame of said module device.

15. The apparatus of claim 10, wherein said anti-bumping board of the optical storage medium with anti-bumping system should be a rigid structure as the preferred embodiment.

16. The apparatus of claim 10, wherein said anti-bumping board of the optical storage medium with anti-bumping system should have a through hole.

17. An optical storage medium with an anti-bumping system comprising;
a body device;
a module device mounting on said body which including a frame mounted on it;
a transmission device including a motor of the optical storage disk on said module device which can activate; and
an anti-bumping system positioning on said module device; and said anti-bumping system positioning between said optical storage disk and said body device for changing the airflow field structure on the top side of said optical storage disk, wherein it can balance the up-down airflow pressure of said optical storage disk.

18. The apparatus of claim 17, wherein said module device of the optical storage medium with anti-bumping system includes a readable module.

19. The apparatus of claim 17, wherein said module device of the optical storage medium with anti-bumping system includes a recording module.

20. The apparatus of claim 17, wherein said anti-bumping system of the optical storage medium with anti-bumping system should be an anti-bumping board.

21. The apparatus of claim 17, wherein said anti-bumping board of the optical storage medium with anti-bumping system should be screwed with the frame of said module device.

22. The apparatus of claim 17, wherein said anti-bumping board of the optical storage medium with anti-bumping system should be a rigid structure as the preferred embodiment.

23. The apparatus of claim 17, wherein said anti-bumping board of the optical storage medium with anti-bumping system should have a through hole.
